(19) United States
(12) Patent Application Publication
(10) Pub. No.: US 2026/0065156 A1
(43) Pub. Date: Mar. 5, 2026

(54) WEIGHT DATA QUANTIZATION METHOD, APPARATUS, AND ELECTRONIC DEVICE

(71) Applicant: Smarter Silicon (Shanghai) Technologies Co., Ltd., Shanghai (CN)

(72) Inventors: Zhuo YANG, Shanghai (CN); Zhenbo LIU, Shanghai (CN); Yubin CAO, Shanghai (CN)

(21) Appl. No.: 19/310,120

(22) Filed: Aug. 26, 2025

(30) Foreign Application Priority Data
Aug. 30, 2024 (CN) 202411217119.4

(51) Int. Cl. G06N 20/00

(52) U.S. Cl. CPC G06N 20/00

(57) ABSTRACT

A weight data quantization method includes determining quantization parameters layer by layer for all processing layers of an artificial intelligence model to be quantized and, after the quantization parameters of all the processing layers of the artificial intelligence model to be quantized are determined, determining quantized weights of all the processing layers based on the quantization parameters of all the processing layers. A quantization parameter determined for each processing layer includes a quantization parameter of a current processing layer and quantization parameters of all the processing layers prior to the current processing layer. The quantization parameter of the current processing layer is determined for a first time. The quantization parameters of all the processing layers prior to the current processing layer are updated based on original quantization parameters of all the processing layers prior to the current processing layer.

### CROSS-REFERENCES TO RELATED APPLICATION

The present disclosure claims priority to Chinese Patent Application No. 202411217119.4 filed on Aug. 30, 2024, the entire content of which is incorporated herein by reference.

### FIELD OF TECHNOLOGY

The present disclosure relates to the model processing technology field and, more particularly, to a weight data quantization method, a weight data quantization apparatus, and an electronic device.

### BACKGROUND

The performance bottleneck of an existing large model lies primarily in the bandwidth consumed to read weight data. During a decoding phase of an operation, each time the large model generates a token, the target model needs to read the complete weight data. The weight data of the large model is large and requires much resource, which affects the overall performance of the large model. Thus, quantization processing on the weight data of the large model is necessary. Since the large model includes many processing layers, for the quantization operation of the weight data, the quantization parameter is difficult to train.

### SUMMARY

One aspect of this disclosure provides a weight data quantization method. The method includes determining quantization parameters layer by layer for all processing layers of an artificial intelligence model to be quantized and, after the quantization parameters of all the processing layers of the artificial intelligence model to be quantized are determined, determining quantized weights of all the processing layers based on the quantization parameters of all the processing layers. A quantization parameter determined for each processing layer includes a quantization parameter of a current processing layer and quantization parameters of all the processing layers prior to the current processing layer. The quantization parameter of the current processing layer is determined for a first time. The quantization parameters of all the processing layers prior to the current processing layer are updated based on original quantization parameters of all the processing layers prior to the current processing layer.

Another aspect of this disclosure provides a weight data quantization apparatus, including a parameter determination module and a weight determination module. The parameter determination module is configured to determine quantization parameters layer by layer for all processing layers of an artificial intelligence model to be quantized. A quantization parameter determined for each processing layer includes a quantization parameter of a current processing layer and quantization parameters of all the processing layers prior to the current processing layer. The quantization parameter of the current processing layer is determined for a first time. The quantization parameters of all the processing layers prior to the current processing layer are updated based on original quantization parameters of all the processing layers prior to the current processing layer. The weight determination module is configured to, after the quantization parameters of all the processing layers of the artificial intelligence model to be quantized are determined, determine quantized weights of all the processing layers based on the quantization parameters of all the processing layers.

Another aspect of this disclosure provides an electronic device, including one or more processors and one or more memories. The one or more memories store a computer program that, when executed by the one or more processors, causes the one or more processors to determine quantization parameters layer by layer for all processing layers of an artificial intelligence model to be quantized and, after the quantization parameters of all the processing layers of the artificial intelligence model to be quantized are determined, determine quantized weights of all the processing layers based on the quantization parameters of all the processing layers. A quantization parameter determined for each processing layer includes a quantization parameter of a current processing layer and quantization parameters of all the processing layers prior to the current processing layer. The quantization parameter of the current processing layer is determined for a first time. The quantization parameters of all the processing layers prior to the current processing layer are updated based on original quantization parameters of all the processing layers prior to the current processing layer.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a weight data quantization method according to some embodiments of the present disclosure.

FIG. 2 is a schematic flowchart of determining a quantization parameter gradually in layers according to some embodiments of the present disclosure.

FIG. 3 is a schematic structural diagram of a weight data quantization apparatus according to some embodiments of the present disclosure.

### DETAILED DESCRIPTION

The technical solutions of embodiments of the present disclosure are described in detail in connection with the accompanying drawings of embodiments of the present disclosure. Obviously, the described embodiments are merely some embodiments of the present disclosure and not all embodiments. Based on embodiments of the present disclosure, all other embodiments obtained by those of ordinary skill in the art without creative efforts shall fall within the scope of the present disclosure.

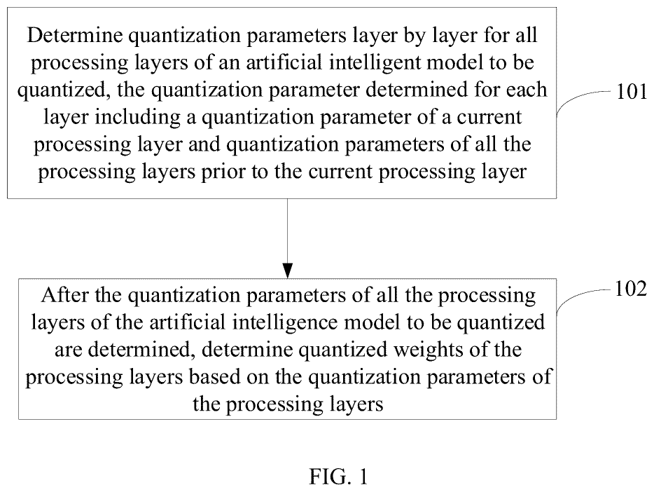

FIG. 1 is a schematic flowchart of a weight data quantization method according to some embodiments of the present disclosure. As shown in FIG. 1, the weight data quantization method includes the following processes.

At 101, quantization parameters are determined gradually by layers for all processing layers of an artificial intelligence model to be quantized. The quantization parameter determined for each layer includes a quantization parameter of a current processing layer and quantization parameters of all the processing layers prior to the current processing layer.

The artificial intelligence model to be quantized can be a machine learning model with a large number of parameters and a complex structure. Thus, the types of the large model in the field are not limited in the present disclosure. For example, the large model can include language processing models, image processing models, and particularly large language models based on a transform architecture.

The quantization parameters of the current processing layer can be determined for the first time, while the quantization parameters of all the processing layers prior to the current processing layer can be updated based on the original quantization parameters. That is, the artificial intelligence model can include a plurality of processing layers. When quantization processing is performed on the artificial intelligence model, starting from the first processing layer, the quantization parameters can be sequentially determined layer by layer, such as in the order of the first processing layer, the second processing layer, the third processing layer, and so on. When a quantization parameter of a certain processing layer is determined, the determined quantization parameters can include the quantization parameter of the current layer and the quantization parameters of all the processing layers prior to the current processing layer. Since the quantization parameters of the processing layers prior to the current processing layer have already been determined previously, during the quantization parameter determination process of the current processing layer, the originally determined quantization parameters of the processing layers prior to the current processing layer can be updated.

For example, when the quantization parameter of the first processing layer is determined, the determined quantization parameter can include only the quantization parameter of the first processing layer. When the quantization parameter of the second processing layer is determined, the determined quantization parameter can include the quantization parameters of the first processing layer and the second processing layer, and the originally recorded quantization parameter of the first processing layer can be updated to the newly determined quantization parameter of the first processing layer.

When the quantization parameter of the third processing layer is determined, the determined quantization parameter can include the quantization parameters of the first processing layer, second processing layer, and third processing layer, and the originally recorded quantization parameters of the first processing layer and the second processing layer can be updated to the newly determined quantization parameters of the first processing layer and the second processing layer, and so on.

When the quantization parameter of the current processing layer is determined, the quantization parameter of the current processing layer can be determined, and the quantization parameters of all the processing layers prior to the current processing layer can be updated. That is, when the quantization parameter of the current processing layer is determined, all previous data related to the current processing layer and possibly affecting the accuracy of the weight/quantization parameter of the current processing layer can be considered to reduce the loss in the quantization to improve the overall prediction accuracy.

At 102, after the quantization parameters of all the processing layers of the artificial intelligence model to be quantized are determined, quantized weights of the processing layers are determined based on the quantization parameters of the processing layers.

After the quantization parameter of the last processing layer of the artificial intelligence model to be quantized is determined using the above layer-by-layer processing method, the quantization parameter determined for the last processing layer can be determined as the final quantization parameter of the artificial intelligence model to be quantized. The final quantization parameter can include the quantization parameters of all the processing layers of the artificial intelligence model to be quantized.

Based on the quantization parameters of the processing layers, the quantized weights of the processing layers can be determined based on the quantization parameters of the respective layers. Since weight data takes up a large proportion of various types of data in the artificial intelligence model, after the original weight data of the artificial intelligence is quantized, the resource consumption of the artificial intelligence model for the weight data can be greatly saved in the processing operation.

In the weight data quantization method of embodiments of the present disclosure, a quantization method of layer-by-layer accumulation across multiple processing layers of the artificial intelligence model can be used to gradually transition from local quantization to global quantization. The problem that the quantization parameters are difficult to train when the number of processing layers of the artificial intelligence model is large can be solved. Meanwhile, the loss of prediction accuracy when each of the processing layers is quantized individually can be avoided in the existing solution.

In the above embodiment, the loss function used to determine the quantization parameters includes a first sub-function and a second sub-function. The first sub-function characterizes the activation value error of the current processing layer, and the second sub-function characterizes the weight loss of the current quantization parameter determination process.

In embodiments of the present disclosure, a loss function used to determine the quantization parameter can include a first sub-function and a second sub-function. The first sub-function can represent an activation value error of the current processing layer. The second sub-function can represent the weight loss in the determination process of the current quantization parameter. The determination process of the current quantization parameter can include the determination process of the quantization parameter of the current processing layer. A one-time quantization parameter determination process can be performed on each processing layer. The weight loss of the current quantization parameter determination process can be the weight loss before and after quantizing the current processing layer, a cumulation of the weight loss of all the processing layers that have been determined with the quantization parameters including the current processing layer, or a cumulation representing the weight loss of at least one processing layer.

There are two categories of weight compression solutions. In one category, the activation value error can be minimized before and after the compression during the compression process. In the other category, a small batch of training data can be input in the quantization process, since the original weight value is not considered in the quantization, the training data can be easily overfit to cause the quantized artificial intelligence model to have poor generalization. In the second category method, the training data may not be needed during the quantization process, and only the minimization of the weight value error before and after the quantization process may need to be considered. The problem of the processing method can include that the prediction accuracy of the original artificial intelligence model can be reduced. The above two categories of methods can include a relatively complicated mathematical derivation and a solving process.

In embodiments of the present disclosure, during the quantization parameter determination process of the processing layers of the artificial intelligence model, the loss function can include the activation value error member corresponding to the output result accuracy of the artificial intelligence model and the weight loss member corresponding to the generalization capability of the artificial intelligence model. Thus, the loss function can consider both the prediction accuracy and the generalization capability of the artificial intelligence model to ensure the processing effect of the artificial intelligence model after the quantization.

In some embodiments, the weight loss can represent only the weight error of the current processing layer. That is, when the quantization parameter of the current processing layer is determined, the weight error before and after the quantization of the current processing layer can be considered independently, without considering the weight error caused by the quantization parameters of other processing layers. Since the quantization parameters are determined layer by layer, the loss function can consider the weight error of the processing layer each time. During the determination process of the quantization parameters layer by layer, the determination process of the quantization parameters of all the processing layers can consider the weight error for the processing layer to eventually cover the weight error of all the processing layers. Through the quantization layer by layer from local to local, the grain quantization parameter of the artificial intelligence model can be determined to improve the quantization accuracy at a certain degree. In the implementation, since the loss function combines the activation value error and the weight error, the prediction accuracy and the generalization capability of the quantized artificial intelligence model can be well ensured.

Mutual influences may exist between different processing layers in the artificial intelligence model. The error of an earlier processing layer can accumulate continuously in the subsequent processing layers to affect the overall processing effect of the artificial intelligence model. Therefore, in other embodiments of the present disclosure, the weight loss can represent the weight error of the current processing layer and the accumulated weight error of all the processing layers prior to the current processing layer. In the present disclosure, the weight loss can be determined based on the weight error of the current processing layer and the weight errors of all the processing layers prior to the current processing layer. Each time the quantization parameter is determined, the accumulation of the weight errors of the processing layers corresponding to all the determined or updated weight parameters can be considered to further improve the quantization accuracy.

In some embodiments, the weight loss in the loss function used in the quantization parameter determination process can represent the accumulated weight errors of all the processing layers prior to the current processing layer. Therefore, in connection with the local-to-global quantization processing method, the global weight loss can be appropriately considered to ensure that the artificial intelligence model has good generalization capability after quantization.

Moreover, since the activation function values are transferable, the error of the activation function of the current layer can already reflect the error of the activation function of the processing layers prior to the current processing layer. Therefore, the activation value error of the current processing layer may only need to be considered for the activation value member corresponding to the first sub-function in the loss function without considering the activation value error of the processing layers prior to the current processing layer.

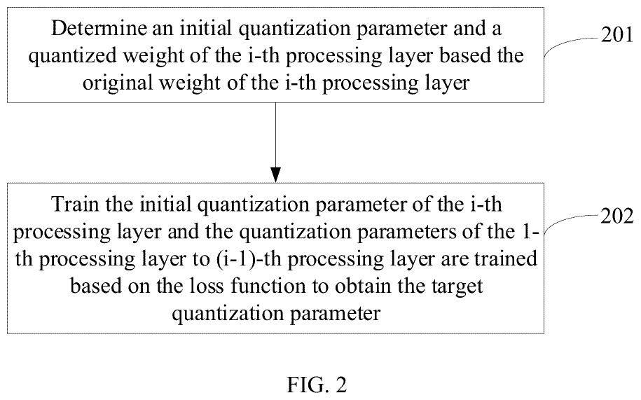

FIG. 2 is a schematic flowchart of determining quantization parameters gradually layer by layer according to some embodiments of the present disclosure. As shown in FIG. 2, determining the quantization parameters layer gradually layer by layer for all the processing layers of the artificial intelligence model to be quantized includes the following processes.

At 201, an initial quantization parameter and a quantized weight of the i-th processing layer are determined based on the original weight of the i-th processing layer.

In some embodiments, the initial quantization parameter and the corresponding initial quantized weight of the i-th processing layer can be calculated through the original weight of the i-th processing layer based on the nearest-neighbor method.

At 202, the initial quantization parameter of the i-th processing layer and the quantization parameters of the 1-th processing layer to (i−1)-th processing layer are trained based on the loss function to obtain the target quantization parameter. The target quantization parameter includes N quantization parameters of the 1-st processing layer to the current processing layer, where N=i.

In some embodiments, the activation value error can represent the norm of the difference in the output value at the current processing layer after the training data passes through the processing layers from the 1-st processing layer to the current processing layer before and after quantizing the weight data of the current processing layer, and/or the weight loss can represent the result of performing a weighted summation on the weight errors of the current processing layer and all the preceding processing layers prior to the current processing layer.

To better understand the technical solution of the present disclosure, a specific example is provided below.

The quantization parameter for the artificial intelligence model to be quantized can be determined according to the following processes.
1. A mathematical description can be established. Assume that the original weight of the i-th layer of the original artificial intelligence model is wᵢ, and the quantized weight is wᵢ(aᵢ), aᵢ is the quantized parameter of the layer, and fᵢ is the inference function of the layer. For a model with N layers, assume the input is x, then:
The output of the first layer is y₁=f₁(x, w₁), and ŷ₁=f₁(x, w₁(a₁));
The output of the second layer is y₂=f₂(y₁, w₂), and ŷ₂=f₂(ŷ₁, w₂(a₂)); and so on, the output of the N-th layer is y_{N}=f_{N}(y_{N-1}, w_{N}), and ŷ_{N}=f_{N}(ŷ_{N-1}, w_{N}(a_{N})).
2. When i=1:
First, the initial a₁ and w₁(a₁) can be calculated through w₁ using the initial quantization method. That is, based on the nearest neighbor method, the initial quantization parameter of the i-th processing layer and the corresponding initially quantized weight can be calculated through the original weight of the i-th processing layer. The initially quantized method includes the nearest neighbor method, an AWQ method, a GPTQ method, which is not limited here.
Then, a₁ can be trained and adjusted according to the loss function ∥y₁−ŷ₁∥+∥w₁−w₁(a₁)∥. The quantization parameter can be trained and adjusted using the automatic differentiation function of the deep learning frame.

The above process can include, first based on the initial weight value, obtaining the initial value of the quantization parameter using the nearest neighbor method or other appropriate methods, and then training and adjusting the quantization parameter based on the initial value to obtain a better solution.

∥y₁−ŷ₁∥ of the loss function can be used to measure the error of the activation value, i.e., the norm of the difference of the activation value before and after the quantization. ∥w₁−w₁(a₁)∥ can be used to measure the error of the weight, i.e., the norm of the weight difference before and after the quantization.
3. When i=2:
First, the initial a₂ and w₂(a₂) can be calculated through w₂ using the initial quantization method.
Then, 1 and a₂ can be trained and adjusted according to the loss function

$$‖ {y}_{2} - {\hat{y}}_{2} ‖ + {\sum }_{i = 1}^{2} {λ}_{i}^{( 2 )} ‖ {w}_{i} - {w}_{i} ( {a}_{i} ) ‖ .$$

∥y₂−ŷ₂∥ of the loss function can be used to measure the error of the activation value.

$${\sum }_{i = 1}^{2} {λ}_{i}^{( 2 )} ‖ {w}_{i} - {w}_{i} ( {a}_{i} ) ‖$$

can be used to measure the error of the weight, which indicates the weighted average sum of the weight errors of the processing layers from the first processing layer to the i-th processing layer. λ can represent the weight value of the weight error, and λ can be 1/i. That is, the weight values of the weight errors of the processing layers can be the same, e.g., if i=2, λ is ½. Then, with the weighted average sum of the weight errors of the processing layers, the cumulation of the weight errors of the processing layers after being performed with the quantization parameter determination to effectively ensure the generalization capability of the quantized model.

In some other embodiments, for the weight errors of different processing layers, the corresponding weight value λ can be different. For example, when a layer is closer to the current processing layer, the corresponding weight value λ can be larger. When the quantization parameter is determined for the third layer, the weight value λ of the weight error of the third layer can be the largest, the weight value λ of the weight error of the second layer can be medium, and the weight value λ of the weight error of the first layer can be the smallest.

In some other embodiments, λ can be 1. That is, λ does not exist. Then, the weight errors of the current processing layer and the processing layers prior to the current processing layer can be arithmetically averaged. That is, the weight loss in the loss function can be

$$( {\sum }_{i = 1}^{N} {λ}_{i}^{( 2 )} ‖ {w}_{i} - {w}_{i} ( {a}_{i} ) ‖ ) / N .$$

The corresponding loss function can be

$$‖ {y}_{2} - {\hat{y}}_{2} ‖ + ( {\sum }_{i = 1}^{N} ‖ {w}_{i} - {w}_{i} ( {a}_{i} ) ‖ ) / N .$$

wherein N=i.
4. And so on, when i=N,
First, the initial a_{N} and w_{N}(a_{N}) can be calculated through w_{N} using the nearest neighbor method.
Then, a₂, a₂, . . . , a_{N} can be trained and adjusted according to the loss function

$$‖ {y}_{N} - {\hat{y}}_{N} ‖ + {\sum }_{i = 1}^{N} {λ}_{i}^{( N )} ‖ {w}_{i} - {w}_{i} ( {a}_{i} ) ‖ .$$

∥y_{N}−ŷ_{N}∥ of the loss function can be used to measure the error of the activation value.

$${\sum }_{i = 1}^{N} {λ}_{i}^{( N )} ‖ {w}_{i} - {w}_{i} ( {a}_{i} ) ‖$$

can be used to measure the weight error.
5. After training and adjustment of N layers, a₁, a₂, . . . , a_{N} can be the final quantization parameter.

In the weight data quantization method of embodiments of the present disclosure, the loss function can include the activation value error and the weight loss, which considers the prediction accuracy and generalization capability of the quantized model, ensuring the effectiveness of the artificial intelligence model after the quantization.

In some embodiments, the input data corresponding to the output value before quantizing the weight data of the current processing layer can be the same as the input data corresponding to the output value after quantizing the weight data. That is, during the process of determining the quantization parameter, the artificial intelligence model can determine the activation values of the processing layers before and after the quantization using the same input data to determine the activation value errors of the processing layers before and after the quantization.

In some embodiments, the same input data can be input into the model before and after the weight data quantization, the accuracy of the activation value error before and after the weight data quantization can be effectively ensured to further ensure the accuracy of the loss function and improve the performance in determining the quantization parameter. The input data can be a small portion of a large quantity of training data used during the training phase of the artificial intelligence model. Therefore, the weight data quantization can be the quantization based on the small portion of training data, without providing additional training data for the quantization operation of the weight data.

In some embodiments, determining the quantized weights of the processing layers based on the quantization parameters of the processing layers can include determining the quantized weights of the processing layers using a target quantization method based on the quantization parameters of the processing layers. The target quantization method can include, but is not limited to, any one of group-wise quantization, tensor quantization, and channel-wise quantization. The target quantization method can be symmetric quantization or asymmetric quantization. The quantization granularity of group-wise quantization can be the finest, the quantization granularity of channel-wise quantization can be the next fine, and the quantization granularity of the tensor quantization can be the least fine. The appropriate target quantization method can be selected based on the actual application scenario requirements and the hardware performance.

In the weight data quantization method of embodiments of the present disclosure, during the process of determining the quantization parameter of the processing layer of the artificial intelligence model, the adopted loss function can include the activation value error member corresponding to the output result of the artificial intelligence model and the weight loss member corresponding to the generalization capability of the artificial intelligence model. Thus, the method can consider the prediction accuracy and the generalization capability of the original artificial intelligence model. The quantization process can adopt a quantization method of cumulation layer by layer to transition from the local quantization to global quantization to solve the difficulty in training the quantization parameter when the number of layers of the artificial intelligence model is too large.

To simplify the description, the above embodiments can be described as a series of action combinations. However, those skilled in the art should understand that the present disclosure is not limited by the described sequence of actions, because, according to the present disclosure, some steps can be performed in another sequence or simultaneously. Then, those skilled in the art should know that the described embodiments of the present disclosure belong to some embodiments of the present disclosure, and the involved actions and modules are not necessarily required by the present disclosure.

In embodiments of the present disclosure, the method is described in detail. The method of the present disclosure can be implemented in various apparatuses. Thus, the present disclosure further provides an apparatus, and specification embodiments are described below.

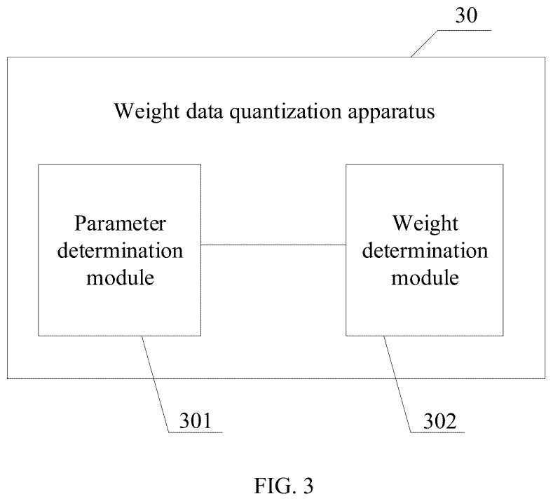

FIG. 3 is a schematic structural diagram of a weight data quantization apparatus 30 according to some embodiments of the present disclosure. As shown in FIG. 3, the weight data quantization apparatus 30 includes a parameter determination module 301 and a weight determination module 302.

The parameter determination module 301 can be configured to determine the quantization parameters of all the processing layers of the artificial intelligence model to be quantized layer-by-layer. The quantization parameter determined for each processing layer can include the quantization parameter of the current processing layer and the quantization parameters of all the processing layers prior to the current processing layer. The quantization parameter of the current processing layer can be determined for the first time, and the quantization parameters of all the processing layers prior to the current processing layer can be updated based on the original quantization parameters of all the processing layers prior to the current processing layer.

The weight determination module 302 can be configured to, after the quantization parameters of all the processing layers of the artificial intelligence model to be quantized have been determined, determine the quantized weights of the processing layers based on the quantization parameters of the processing layers.

With the weight data quantization apparatus of embodiments of the present disclosure, the quantization method of cumulation layer by layer for the processing layers of the artificial intelligence model can be implemented to transition from the local quantization to the global quantization. The problem of the difficulty in training the quantization parameters of the artificial intelligence model due to too many processing layers can be solved, and the problem of the prediction accuracy loss caused when the processing layers are quantized individually in the existing solution can also be avoided.

In one implementation, the loss function used for determining the quantization parameters can include a first sub-function and a second sub-function. The first sub-function characterizes the activation value error of the current processing layer, and the second sub-function characterizes the weight loss in the current quantization parameter determination process.

In some embodiments, the loss function used to determine the quantization parameter can include a first sub-function and a second sub-function. The first sub-function can represent the activation value error of the current processing layer, and the second sub-function can represent the weight loss of the current quantization parameter determination process.

In some embodiments, the weight loss can represent the cumulation of the weight errors of all the processing layers prior to the current processing layer, which can be determined based on the weight error of the current processing layer and the weight errors of the processing layers prior to the current processing layer.

In some embodiments, the parameter determination module may include an initial processing module configured to determine the initial quantization parameter and the quantized weight of the i-th processing layer based on the original weight of the i-th processing layer, and an initial processing module configured to train the initial quantization parameter of the i-th processing layer and the quantization parameters of the 1st to (i−1)-th processing layers based on the loss function to obtain the target quantization parameter. The target quantization parameter can include the quantization parameters of the 1st processing layer to the current i-th processing layer.

In some embodiments, the initial processing module can be configured to calculate the initial quantization parameter of the i-th processing layer and the corresponding initial quantized weight through the original weight of the i-th processing layer based on the nearest neighbor method.

In some embodiments, the activation value error can represent the norm of the difference between the output values at the current processing layer after the training data is processed by the processing layers from the 1st processing layer to the current processing layer before and after the weight data is quantized, and/or the weight loss can represent the result of weighted sum of the weight errors of the current processing layer and all the processing layers prior to the current processing layer.

In some embodiments, the input data corresponding to the output value before the weight data quantization of the current processing layer can be the same as the input data corresponding to the output value after the weight data quantization.

In some embodiments, the weight determination module can be configured to determine the quantized weights of the processing layers in the group-wise quantization method based on the quantization parameters of the processing layers.

For the implementation and other possible implementations of the weight data quantization apparatus and the modules included in the weight data quantization apparatus, reference can be made to the description of corresponding contents of the method embodiments, which is not repeated here.

Based on the above descriptions, the weight data quantization apparatus can include the following beneficial effects.
1. Since the loss function that includes the activation value error and the weight loss is adopted, the original prediction accuracy and generalization capability of the artificial intelligence model can be considered. Therefore, the quantization accuracy can be high, and the application scenarios can be rich.
2. Compared to the existing model quantization solution, the implementation solution of the weight data quantization apparatus does not involve complex mathematical derivation and solution. Thus, the computational power requirement can be low, and the quantization efficiency can be high.
3. The quantization process of the weight data quantization apparatus can be completed based on the model training process to determine the model quantization parameters based on a small batch of training data.

Any of the weight data quantization apparatuses described above can include one or more processors and one or more memories. The parameter determination module, weight determination module, initial processing module, and other modules described above can be all stored in the one or more memories as program modules, and the corresponding functions can be realized by the one or more processors executing the above program modules stored in the one or more memories.

The one or more processors each can include a core, and the core can call the corresponding program modules from the one or more memories. One or more cores can be provided to process the revisit data by adjusting the core parameters.

The memories can include forms such as non-permanent memory in computer-readable media, random access memory (RAM), and/or non-volatile memory, such as read-only memory (ROM) or flash RAM. The memories can include at least one memory chip.

In some embodiments, a computer-readable storage medium is also provided, which can be directly loaded into the internal memory of a computer and contains software code. After the computer program being loaded and executed by the computer, the computer can be configured to realize the steps of any of the weight data quantization methods described above.

In some embodiments, a computer program product can also be provided, which can be directly loaded into the internal memory of a computer and contains software code. After being loaded and executed by the computer, the computer can be configured to realize the steps of any of the weight data quantization methods described above.

Embodiments of the present disclosure further provide an electronic device. An artificial intelligence model can be provided on the electronic device. The weights of each processing layer of the artificial intelligence model can be determined based on any of the weight data quantization methods above. Combined with the contents of the above embodiments, the artificial intelligence model of the electronic device can adopt the quantization method described above to realize the quantization of weight data. The corresponding quantization method, under the premise of ensuring the prediction accuracy and generalization capability of the quantized model, can enable a high degree of compression of the quantized weight data to reduce the hardware capability requirements of the electronic device for running the artificial intelligence model.

Each embodiment of the present disclosure is described in a progressive manner. Each embodiment focuses on the differences from other embodiments, and the same or similar parts among the embodiments can be referred to each other. Since the disclosed apparatus of embodiments of the present disclosure corresponds to the method of embodiments of the present disclosure, the description can be relatively simple, and the relevant parts can be referred to the method section.

In the present disclosure, the relational terms such as first and second are merely used to distinguish one entity or operation from another entity or operation, and do not necessarily require or imply any actual relationship or order between these entities or operations. Moreover, the terms “comprising,” “including,” or any other variation thereof are intended to cover non-exclusive inclusions, so that a process, method, article, or device that includes a list of elements does not include only those elements but may also include other elements that are not explicitly listed, or may also include elements inherent to such a process, method, article, or device. Without more constraints, an element defined by the phrase “comprising a . . . ” does not exclude the existence of additional identical elements in the process, method, article, or device that includes the element.

The steps of the methods or algorithms described above can be directly implemented by hardware, software modules executed by the processors, or a combination thereof. Software modules can be placed in random access memory (RAM), memory, read-only memory (ROM), electrically programmable ROM, electrically erasable programmable ROM, registers, hard disks, removable disks, CD-ROMs, or any other form of storage medium known in the technical field.

The above description of embodiments of the present disclosure can enable those skilled in the art to implement or use the present disclosure. Various modifications to these embodiments will be apparent to those skilled in the art, and the general principles defined here can be applied to other embodiments without departing from the spirit or scope of the present disclosure. Therefore, the present disclosure is not limited to the above embodiments but conforms to the widest scope consistent with the principles and novel features of the present disclosure.

What is claimed is:

1. A weight data quantization method comprising:
determining quantization parameters layer by layer for all processing layers of an artificial intelligence model to be quantized, wherein a quantization parameter determined for each processing layer includes a quantization parameter of a current processing layer and quantization parameters of all the processing layers prior to the current processing layer, the quantization parameter of the current processing layer is determined for a first time, and the quantization parameters of all the processing layers prior to the current processing layer are updated based on original quantization parameters of all the processing layers prior to the current processing layer; and
after the quantization parameters of all the processing layers of the artificial intelligence model to be quantized are determined, determining quantized weights of all the processing layers based on the quantization parameters of all the processing layers.

2. The weight data quantization method according to claim 1, wherein a loss function used to determine the quantization parameters includes:
a first sub-function representing an activation value error of the current processing layer; and
a second sub-function representing weight loss during a current time quantization parameter determination process.

3. The weight data quantization method according to claim 2, wherein:
the weight loss represents an accumulation of weight errors of the current processing layer and all the processing layers prior to the current processing layer and is determined based on a weight error of the current processing layer and weight errors of all the processing layers prior to the current processing layer.

4. The weight data quantization method according to claim 2, wherein determining the quantization parameters layer by layer for all the processing layers of the artificial intelligence model to be quantized includes:
determining an initial quantization parameter and a quantized weight of an i-th processing layer based on an original weight of the i-th processing layer;
training the initial quantization parameter of the i-th processing layer and quantization parameters of 1st processing layer to (i−1)-th processing layer based on the loss function to obtain a target quantization parameter, the target quantization parameters including N quantization parameters from the 1st processing layer to the current processing layer, and N being equal to i.

5. The weight data quantization method according to claim 4, wherein determining the initial quantization parameter and the quantized weight of the i-th processing layer based on the original weight of the i-th processing layer includes:
calculating the initial quantization parameter and the corresponding initial quantized weight of the i-th processing layer based on the original weight of the i-th processing layer in a nearest-neighbor method.

6. The weight data quantization method according to claim 2, wherein:
the activation value error represents a norm of a difference between output values at the current processing layer after training data passes through the processing layers from a 1st processing layer to the current processing layer before and after quantizing the weight data of the current processing layer; and/or
the weight loss represents a result of a weighted sum of the weight errors of the current processing layer and all the processing layers prior to the current processing layer.

7. The weight data quantization method according to claim 6, wherein input data corresponding to the output value before quantizing the weight data of the current processing layer is the same as input data corresponding to the output value after quantizing the weight data.

8. The weight data quantization method according to claim 1, wherein determining the quantized weights of the processing layers based on the quantization parameters of the processing layers includes:
determining the quantized weights of the processing layers in a target quantization method based on the quantization parameters of the processing layers, the target quantization method including any one of group-wise quantization, tensor quantization, or channel-wise quantization.

9. Computer readable storage medium storing computer programs, when executed by one or more processors, the computer programs implementing a weight data quantization method comprising:
determining quantization parameters layer by layer for all processing layers of an artificial intelligence model to be quantized, wherein a quantization parameter determined for each processing layer includes a quantization parameter of a current processing layer and quantization parameters of all the processing layers prior to the current processing layer, the quantization parameter of the current processing layer is determined for a first time, and the quantization parameters of all the processing layers prior to the current processing layer are updated based on original quantization parameters of all the processing layers prior to the current processing layer; and
after the quantization parameters of all the processing layers of the artificial intelligence model to be quantized are determined, determining quantized weights of all the processing layers based on the quantization parameters of all the processing layers.

10. The computer readable storage medium according to claim 9, wherein a loss function used to determine the quantization parameters includes:
a first sub-function representing an activation value error of the current processing layer; and
a second sub-function representing weight loss during a current time quantization parameter determination process.

11. The computer readable storage medium according to claim 10, wherein:
the weight loss represents an accumulation of weight errors of the current processing layer and all the processing layers prior to the current processing layer and is determined based on a weight error of the current processing layer and weight errors of all the processing layers prior to the current processing layer.

12. The computer readable storage medium according to claim 10, wherein the weight data quantization method further comprises:
determining an initial quantization parameter and a quantized weight of an i-th processing layer based on an original weight of the i-th processing layer; and
training the initial quantization parameter of the i-th processing layer and quantization parameters of 1st processing layer to (i−1)-th processing layer based on the loss function to obtain a target quantization parameter, the target quantization parameters including N quantization parameters from the 1st processing layer to the current processing layer, and N being equal to i.

13. An electronic device comprising:
one or more processors; and
one or more memories storing a computer program that, when executed by the one or more processors, causes the one or more processors to:
determine quantization parameters layer by layer for all processing layers of an artificial intelligence model to be quantized, wherein a quantization parameter determined for each processing layer includes a quantization parameter of a current processing layer and quantization parameters of all the processing layers prior to the current processing layer, the quantization parameter of the current processing layer is determined for a first time, and the quantization parameters of all the processing layers prior to the current processing layer are updated based on original quantization parameters of all the processing layers prior to the current processing layer; and
after the quantization parameters of all the processing layers of the artificial intelligence model to be quantized are determined, determine quantized weights of all the processing layers based on the quantization parameters of all the processing layers.

14. The electronic device according to claim 13, wherein a loss function used to determine the quantization parameters includes:
a first sub-function representing an activation value error of the current processing layer; and
a second sub-function representing weight loss during a current time quantization parameter determination process.

15. The electronic device according to claim 14, wherein:
the weight loss represents an accumulation of weight errors of the current processing layer and all the processing layers prior to the current processing layer and is determined based on a weight error of the current processing layer and weight errors of all the processing layers prior to the current processing layer.

16. The electronic device according to claim 14, wherein the one or more processors are further configured to:
determine an initial quantization parameter and a quantized weight of an i-th processing layer based on an original weight of the i-th processing layer; and
train the initial quantization parameter of the i-th processing layer and quantization parameters of 1st processing layer to (i−1)-th processing layer based on the loss function to obtain a target quantization parameter, the target quantization parameters including N quantization parameters from the 1st processing layer to the current processing layer, and N being equal to i.

17. The electronic device according to claim 16, wherein the one or more processors are further configured to:
calculate the initial quantization parameter and the corresponding initial quantized weight of the i-th processing layer based on the original weight of the i-th processing layer in a nearest-neighbor method.

18. The electronic device according to claim 14, wherein:
the activation value error represents a norm of a difference between output values at the current processing layer after training data passes through the processing layers from a 1st processing layer to the current processing layer before and after quantizing the weight data of the current processing layer; and/or
the weight loss represents a result of a weighted sum of the weight errors of the current processing layer and all the processing layers prior to the current processing layer.

19. The electronic device according to claim 18, wherein input data corresponding to the output value before quantizing the weight data of the current processing layer is the same as input data corresponding to the output value after quantizing the weight data.

20. The electronic device according to claim 13, wherein the one or more processors are further configured to:
determine the quantized weights of the processing layers in a target quantization method based on the quantization parameters of the processing layers, the target quantization method including any one of group-wise quantization, tensor quantization, or channel-wise quantization.
